(19) United States
(12) Patent Application Publication
(10) Pub. No.: US 2001/0037318 A1
(43) Pub. Date: Nov. 1, 2001

(54) Third party payment in e-commerce

(76) Inventors: Helena Lindskog, Karlstad (SE); Mikael Nilsson, Karlstad (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/741,011

(22) Filed: Dec. 21, 2000

Related U.S. Application Data
(60) Provisional application No. 60/207,223, filed on May 26, 2000.

(51) Int. Cl. G06F 17/60; H04K 1/00; H04L 9/00

(52) U.S. Cl. 705/78; 705/39; 705/38; 705/75

(57) ABSTRACT

An electronic transaction is made between a seller and two or more customers by performing an initial transaction between a first customer of the two or more customers and the seller, wherein the initial transaction provides the seller with an identity of the first customer, an amount to be paid by the first customer and identities of a remaining group of the two or more customers. A subsequent transaction is then performed between the seller and each customer identified by the remaining group of the two or more customers. The subsequent transaction provides the seller with information that completes the electronic transaction.

This application claims the benefit of U.S. Provisional Application No. 60/207,223 filed in the U.S. Patent and Trademark Office on May 26, 2000; the entire content of which is hereby incorporated by reference.

### BACKGROUND

The invention relates to electronic commerce (“e-commerce”), and more particularly to techniques and apparatuses for making a transaction between multiple parties.

The Internet plays an increasingly important part in the day-to-day lives of many people. The Internet has historically grown in an environment in which computers are connected via a wire (e.g., a wire-line telephone or other wirebased connection), which makes them relatively immobile. However, modern advances in technology are providing an ever increasing ability to maintain an Internet connection via mobile technology (e.g., by means of cellular communications equipment). Thus, it is anticipated that Internet-based services will continue to increase their infiltration into modern life.

Regardless of whether a mobile or fixed connection to the Internet is used, one service that the Internet provides is “web shopping” (the word “web” refers to the so-called “World Wide Web”), which is the ability of a user (“customer”) to transact business with a service/merchandise provider (“seller”) without ever having to travel to the place of business of the seller. Instead, the entire transaction takes place over the Internet, between computers operated by the customer and the seller. Part of this transaction involves one party (e.g., the customer) making a payment to the other (e.g., the seller). It is important to make sure that this transaction is secure with respect to fraud and eavesdropping issues.

Techniques for making a secure payment between a customer and a seller are known. In particular, making a secure payment involves having a digital certificate, either in the mobile device, connected to the computer, or in the web browser itself. The digital certificate grants payment from a third party, preferably a bank, to the owner of the site.

Digital certificates are well-known in the art, and many conform to a standard such as X.509. A digital certificate establishes the owner's credentials on the Web. A certification authority may be established for the purpose of issuing digital certificates to the public, and each digital certificate may include the owner's name, a serial number, expiration dates, a copy of the certificate holder's public key (which can be used for encrypting and decrypting messages and digital signatures), and the digital signature of the certificate-issuing authority so that a recipient can verify that the certificate is real. To enable authenticated users to look up other users' public keys, digital certificates can be kept in registries.

The “digital signature” referred to above is a set of data that may be transmitted along with, or in a separate transmission from, an electronic message, document, or other information. The digital signature is used by the recipient to ensure that the electronic message or document that has been received was not changed by anyone or anything in the course of its communication. To create a digital signature, the message (or other document or information) to be transmitted is processed by special software to create a mathematical summary (a so-called “hash”) of the original message. The sender's private key is then used to encrypt the hash. The encrypted hash becomes the digital signature of the message. Upon receipt of the original message, the receiver makes his own hash of the received message. The sender's public key is then used to decrypt the received hash, and the decrypted received hash is compared to the receiver-generated one. If they match, then the received message is deemed to be valid.

A problem with conventional e-Commerce payment techniques is that they do not provide for the possibility that a single transaction may involve more than one customer, each of which will contribute only a part of the total amount owed. This can be the case, for example, when buying expensive goods, like a car, or when buying inexpensive goods, such as pizza. The problem is that all of the parties (i.e., the web service/merchandise provider as well as the plurality of payment providers) must be able to identify themselves before payment can take place.

Thus, there is a need for a standardized methodology for dealing with this sort of payment situation.

### SUMMARY

An electronic transaction is made between a seller and two or more customers by performing an initial transaction between a first customer of the two or more customers and the seller, wherein the initial transaction provides the seller with an identity of the first customer, an amount to be paid by the first customer and identities of a remaining group of the two or more customers. A subsequent transaction is then performed between the seller and each customer identified by the remaining group of the two or more customers. The subsequent transaction provides the seller with information to complete the electronic transaction.

### BRIEF DESCRIPTION OF THE DRAWINGS

The objects and advantages of the invention will be understood by reading the following detailed description in conjunction with the drawings in which:

FIG. 1 illustrates transactions between a seller and two or more customers in accordance with the invention; and

FIG. 2 depicts a method in accordance with the present invention.

### DESCRIPTION

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

The invention will now be described in detail in connection with a number of exemplary embodiments. To facilitate an understanding of the invention, many aspects of the invention are described in terms of sequences of actions to be performed by elements of a computer system. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as “logic configured to” perform a described action.

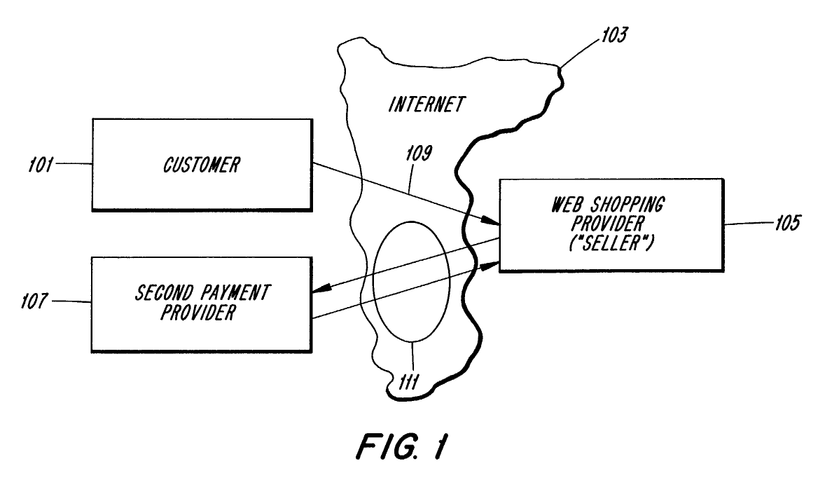

FIG. 1 illustrates a scenario and transactions between a seller and two or more customers in accordance with the invention. A first customer 101 uses the Internet 103 to contact a web shopping or service provider, referred to herein as the “seller” 105. (As used herein and throughout this specification, the terms “customer” and “seller” need not refer to human beings, but may refer only to corresponding devices that are capable of operating in the manner described.) The first customer 101 wishes to buy or otherwise obtain the merchandise or services offered by the seller 105, but does not wish to be solely responsible for the payment. Instead, the customer will rely in whole or in part on two or more other payment providers 107 (“other customers” —only one is depicted in FIG. 1) to provide the remaining money to be exchanged for the desired merchandise and/or services. It should be noted that as used in this specification, the term “money” refers not only to legal tender issued by a government body or agency, but may also refer to other items (whether tangible or intangible) of value and/or necessity for completing a transaction, including but not limited to other goods or services (i.e., in a barter exchange), “points” or other units of credit (e.g., airline miles awarded under a frequent flier program) established by private entities, and even signatures (e.g., for transactions that require signatures from more than two entities that are all on the same side of an agreement, that is, all signing on behalf of the customer and/or all signing on behalf of the seller).

The invention establishes a standardized set of actions that enable the desired electronic transaction to take place. An “electronic transaction” is defined to be a transaction which is conducted via communications on the World Wide Web or the Internet, an intranet, a LAN, a wireless or wired communications network, or by any like type of telecommunications network. In particular, the electronic transaction can be made between the seller 105 and two or more customers 101, 107 by performing an initial transaction 109 between the first customer 101 of the two or more customers 101, 107 and the seller 105, wherein the initial transaction 109 provides the seller 105 with an identity of the first customer 101, an amount to be paid by the first customer 101 and identities the remaining group 107 of the two or more customers. Then, a subsequent transaction 111 is performed between the seller 105 and each customer 107 identified by the remaining group of the two or more customers 101, 107. For each customer identified by the remaining group 107 of the two or more customers 101, 107, the subsequent transaction 111 provides the seller 105 with information about an amount to be paid by said each customer 107.

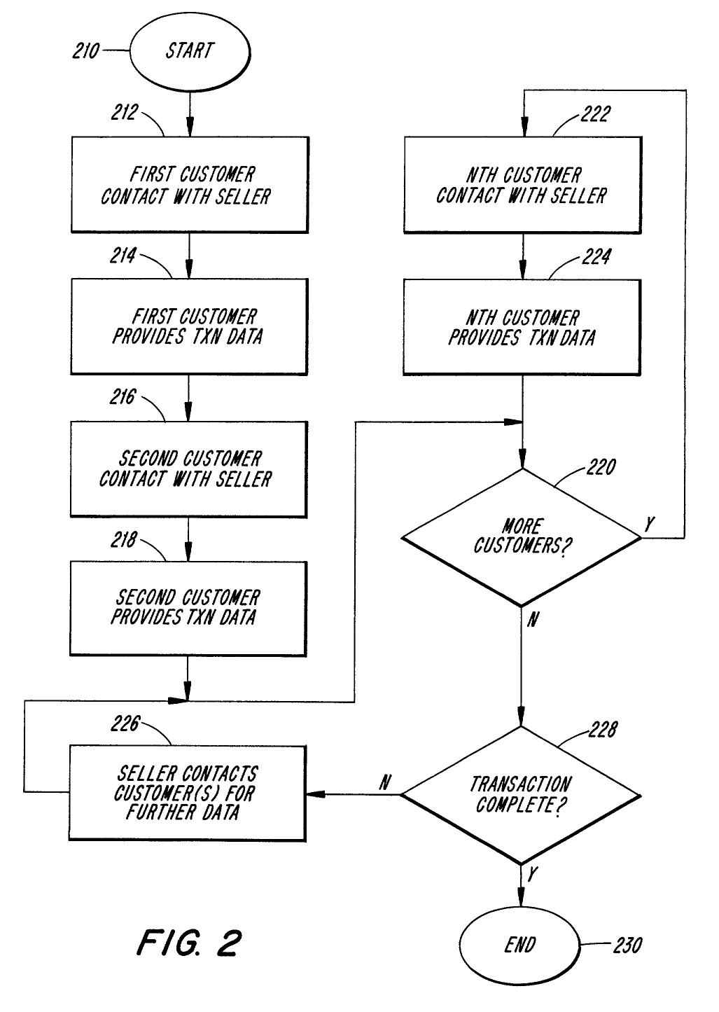

FIG. 2 depicts a method in accordance with the present invention. The method begins in step 210 and proceeds to step 212 where a first customer contacts the seller (e.g., customer 101 contacts seller 105 via the Internet 103). For the purposes of illustration, the present invention is described in terms of the customers contacting the seller. In accordance with alternative embodiments of the invention, the seller may contact the customer or customers. Once contact has been made between the first customer and the seller, the first customer provides transaction data to the seller. The transaction data may include information about the product or service to be purchased (e.g., description, quantity, price), information pertaining to the digital certificate, and also information about one or more other customers who will be providing at least part of the payment for the transaction. Once the seller has been provided with the transaction data, the method proceeds to step 216 in which contact is made between the seller and a second customer (e.g., seller 105 and second payment provider 107). The contact between the seller and the second customer, or any subsequent customers specified in the transaction data, may be made while the first customer is still in contact with the seller or after contact between the first customer and seller has ended.

Upon establishing contact between the second customer and the seller in step 216, the method proceeds to step 218 in which the second customer provides transaction data. The second customer's transaction data may contain information pertaining to the second customer's digital certificate for payment of the remaining balance, or at least the second customer's share of the remaining balance. In accordance with an alternative embodiment, the second customer may opt not to pay the entire remaining balance and instead pay a portion thereof and provide information about a third customer, who will pay the remainder. Following step 218, the method proceeds to step 220 in which it is determined whether there are any more customers aside from those already contacted by the seller.

If there are more customers, the method proceeds in accordance with the “YES” branch from step 220 to step 222 and contact is made with the Nth (e.g., third) customer. After establishing contact between the Nth customer and the seller, the method proceeds from step 222 to step 224 in which the Nth customer provides her transaction data. The method then proceeds back to step 220 where it is determined whether there are any more customers, in which case the method loops back to step 222 to gather information from any additional customers. If there are no more customers, the method proceeds in accordance with the “NO” branch from step 220 to step 228, in which it is determined whether the transaction is complete.

In step 228 it may be determined that the transaction is not complete. This may happen due to insufficient funds being available to pay for the product or service, or because the seller was not able to contact all of the customers, or one or more of the customers opted not to participate in the transaction upon being contacted. If, for any of these or other reasons, it is determined in step 228 that the transaction is not complete, the method proceeds in accordance with the “NO” branch from step 228 to step 226.

In step 226 the seller contacts either the first customer or other customers participating in the transaction for further transaction data. An instance of the seller contacting another customer due to an incomplete transaction could occur as follows. Suppose, for example, that the transaction involves a college student purchasing a car, wherein the college student specified a financial institution, such as a bank or other lender, as the second customer at which he was preapproved for an automobile loan. If, during the transaction, the seller determined that the preapproved loan was not enough to cover the price of the car, then the seller could contact the college student in accordance with step 226 to either get more funds or to get the name of a third customer (e.g., the student's father) to pay the remainder.

Once step 226 has been completed, the method loops back to step 220 in which it is determined whether there are more customers for the transaction. In step 228 if it is determined that the transaction is complete and no more transaction data is required, the method proceeds to step 230 and ends.

The invention will now be further described in connection with several scenarios. In a first scenario, it is assumed that five friends (e.g., from the same office) agree to buy pizza. One of them (“first customer”) enters the web site, orders the pizzas and, performs all necessary steps to pay her share of the total amount owed to the seller. In addition, as part of this first transaction, this first customer provides information (e.g., in the form of email addresses) that identifies the four other persons involved in the transaction, and may also provide the amount that each person in this remaining group of customers is supposed to pay.

In a subsequent transaction, each of the four persons identified as being part of the remaining group of customers receives an email from the seller. This email may contain a link to a web site where each can pay his or her part of the total amount.

In another scenario, it is assumed that a customer (first customer) wishes to buy a car. Before doing so, she arranges a loan with a bank. In this case, the bank will serve as the customer in the remaining group of customers. When the first customer signs up for the loan, she provides the bank with the name and/or digital certificate of the seller, and in return receives a loan number.

To buy the car, the first customer then contacts the seller (e.g., via the Internet in an initial transaction) and performs whatever steps are necessary to pay her share of the total cost of the car using her standard account. For the balance of the payment, she provides the seller with the loan number and email address of the bank.

In a subsequent transaction, the seller uses the Internet to send an email to a specific loan account set up by the third party payment provider (i.e., the bank). The email in this case includes information indicating the loan number (e.g., this may be supplied in the “subject” line of the email), and a digitally signed payment request.

The third party payment provider processes the email by checking the amount and certificate of the seller. If the information is authenticated, the third party payment provider then digitally signs the payment request, and returns this (i.e., via the Internet) to the seller, thereby completing the transaction.

In a preferred embodiment of the invention, the following steps are generic to all transactions:

1. The first customer sends an HTTP request to the web shopping provider (i.e., seller) containing her digital certificate and public key.

2. The web shopping provider (i.e., seller) accepts the first customer's request, and returns a string to digitally sign. The string contains information that includes some or all of the following: the amount of the transaction, identity of the web shopping provider and a timestamp. The string is provided both in plaintext and digitally signed by the web shopping provider.

3. The customer digitally signs the contract, and sends it back to the seller.

4. The web shopping provider verifies the digital signature of the customer, and asks for the other parties's email addresses, respective amounts and messages.

5. If the other payment providers are actual people, the customer will enter their email addresses, the amounts they owe and an informal message saying something like: “:-) from Patricia . . . ” (i.e., the formulation of this informal message is intended to be meaningful between all of the customers, and is not specified by the invention).

Alternatively, if one or more of the other payment providers is an institution (e.g., a bank or other lending institution), the message to any such payment providers will include meaningful information such as a unique loan number, that the customer and the institution have agreed upon.

6. The web shopping provider will now send a standardized email to the one or more third party payment provider(s), containing the following information: The customer's entered string, signed by the web shopping provider; the string in plaintext; the digital certificate of the payment provider; the amount to pay; and a Uniform Resource Locator (URL) that indicates where the digitally signed string is to be posted.

If, however, the one or more third party payment provider(s) is a person, a URL that indicates where data can be entered in a user friendly way can be sent instead, together with a message saying something like: “Hi, this is from Mama Rosa's Pizza, where your friend Patricia Smith just left you a message saying ‘:-) from Patricia’. Please follow this link to complete your payment: http://www.mamarosa.com/trans=123456789. ”

7. If the seller's email message is parsed by a payment provider's computer, the digitally signed string will be verified, and digitally signed with the payment provider's private key instead, before being sent with an HTTP POST request to the server of the web shopping provider. If the seller's message was sent to a person, the steps will be much like steps 1-3 in this list.

The invention has been described with reference to particular embodiments. However, it will be readily apparent to those skilled in the art that it is possible to embody the invention in specific forms other than those of the preferred embodiment described above. This may be done without departing from the spirit of the invention.

For example, the invention can be applied in mobile as well as non-mobile devices.

Furthermore, the various message contents indicated above are merely suggestions for preferred embodiments, and should not be considered to be essential to the invention. Alternative message contents could instead be used, so long as they provide the parties with the basic information necessary to carry out the transaction, such as purchase amount for the case in which merchandise is being bought.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

What is claimed is:

1. A method of making an electronic transaction between a seller and two or more customers, comprising:
performing an initial transaction between a first customer of the two or more customers and the seller, wherein the initial transaction provides the seller with an identity of the first customer, an amount to be paid by the first customer and identities of a remaining group of the two or more customers; and
performing a subsequent transaction between the seller and each customer identified by the remaining group of the two or more customers,
wherein the subsequent transaction provides the seller with information that completes the electronic transaction.

2. The method of claim 1, wherein the initial transaction comprises:
generating an electronic transaction request by the first customer, wherein the first customer has an identity and the electronic transaction request includes information that authenticates the identity of the first customer;
sending the electronic transaction request from the first customer to the seller;
in response to receipt of the electronic transaction, sending a digital contract from the seller to the first customer;
in response to receipt of the digital contract, digitally signing the digital contract and sending the signed digital contract from the first customer to the seller;
in response to receipt of the signed digital contract, generating a customer inquiry that requests information identifying the remaining group of the two or more customers, and sending the customer inquiry from the seller to the first customer; and
in response to receipt of the customer inquiry, generating a customer inquiry response and sending the customer inquiry response from the first customer to the seller, wherein the customer inquiry response identifies the remaining group of the two or more customers.

3. The method of claim 2, wherein the subsequent transaction between the seller and each customer identified by the remaining group of the two or more customers comprises:
in response to receipt of the customer inquiry response, sending a third party inquiry to each customer identified by the remaining group of the two or more customers identified by the customer inquiry response; and
for each customer identified by the remaining group of the two or more customers identified by the customer inquiry response, generating a third party response in response to receipt of the third party inquiry, and sending the third party response to the seller, wherein the third party response includes information that completes the electronic transaction.

4. The method of claim 3, wherein the third party inquiry includes a loan number and a digitally signed payment request.

5. The method of claim 3, wherein the third party inquiry includes a link to an Internet site that provides resources for a payment provider to generate the third party response.

6. The method of claim 1, wherein the first customer is a person and at least one of the remaining group of the two or more customers is a financial institution.

7. The method of claim 6, wherein the financial institution is a lender.

8. The method of claim 1, wherein the step of performing an initial transaction comprises:
initiation, by the seller, of contact with the first customer.

9. The method of claim 1, wherein the step of performing an initial transaction comprises:
initiation, by the first customer, of contact with the seller.

10. A system for making an electronic transaction between a seller and two or more customers, comprising:
logic that performs an initial transaction between a first customer of the two or more customers and the seller, wherein the initial transaction provides the seller with an identity of the first customer, an amount to be paid by the first customer and identities of a remaining group of the two or more customers; and
logic that performs a subsequent transaction between the seller and each customer identified by the remaining group of the two or more customers,
wherein the subsequent transaction provides the seller with information that completes the electronic transaction.

11. The system of claim 10, wherein the logic that performs the initial transaction comprises:
logic that generates an electronic transaction request by the first customer, wherein the first customer has an identity and the electronic transaction request includes information that authenticates the identity of the first customer;
logic that sends the electronic transaction request from the first customer to the seller;
logic that sends a digital contract from the seller to the first customer in response to receipt of the electronic transaction;
logic that digitally signs the digital contract in response to receipt of the digital contract, and sends the signed digital contract from the first customer to the seller;
logic that generates a customer inquiry in response to receipt of the signed digital contract, wherein the customer inquiry request requests information identifying the remaining group of the two or more customers;
logic that sends the customer inquiry from the seller to the first customer; and
logic that generates a customer inquiry response in response to receipt of the customer inquiry; and
logic that sends the customer inquiry response from the first customer to the seller, wherein the customer inquiry response identifies the remaining group of the two or more customers.

12. The system of claim 11, wherein the logic that performs the subsequent transaction between the seller and each customer identified by the remaining group of the two or more customers comprises:
logic that, in response to receipt of the customer inquiry response, sends a third party inquiry to each customer identified by the remaining group of the two or more customers identified by the customer inquiry response; and
for each customer identified by the remaining group of the two or more customers identified by the customer inquiry response:
logic that generates a third party response in response to receipt of the third party inquiry; and
logic that sends the third party response to the seller, wherein the third party response includes information that completes the electronic transaction.

13. The system of claim 12, wherein the third party inquiry includes a loan number and a digitally signed payment request.

14. The system of claim 12, wherein the third party inquiry includes a link to an Internet site that provides resources for a payment provider to generate the third party response.

15. The system of claim 10, wherein the first customer is a person and at least one of the remaining group of the two or more customers is a financial institution.

16. The system of claim 15, wherein the financial institution is a lender.

17. The system of claim 10 further comprising:
a communication link established by the seller to the first customer prior to performance of the initial transaction.

18. The system of claim 10 further comprising:
a communication link established by the first customer to the seller prior to performance of the initial transaction.

19. Electronic transaction signals between a seller and two or more customers, the electronic transaction signals being made by steps comprising:
performing an initial transaction between a first customer of the two or more customers and the seller, wherein the initial transaction provides the seller with an identity of the first customer, an amount to be paid by the first customer and identities of a remaining group of the two or more customers; and
performing a subsequent transaction between the seller and each customer identified by the remaining group of the two or more customers,
wherein the subsequent transaction provides the seller with information that completes the electronic transaction signals.

20. The electronic transaction signals of claim 19, wherein the initial transaction comprises:
generating an electronic transaction request by the first customer, wherein the first customer has an identity and the electronic transaction request includes information that authenticates the identity of the first customer;
sending the electronic transaction request from the first customer to the seller;
in response to receipt of the electronic transaction, sending a digital contract from the seller to the first customer;
in response to receipt of the digital contract, digitally signing the digital contract and sending the signed digital contract from the first customer to the seller;
in response to receipt of the signed digital contract, generating a customer inquiry that requests information identifying the remaining group of the two or more customers, and sending the customer inquiry from the seller to the first customer; and
in response to receipt of the customer inquiry, generating a customer inquiry response and sending the customer inquiry response from the first customer to the seller, wherein the customer inquiry response identifies the remaining group of the two or more customers.
